(19) United States
(12) Patent Application Publication
(10) Pub. No.: US 2008/0220263 A1
(43) Pub. Date: Sep. 11, 2008

(54) Finishing material panel for construction material

(75) Inventor: Jin Suk Kim, Ulju-gun (KR)

Correspondence Address: LADAS & PARRY LLP, 26 WEST 61ST STREET, NEW YORK, NY, 10023, US

(73) Assignees: JIN SUK KIM; JMNEWTECH CO., LTD.

(21) Appl. No.: 11/788,851

(22) Filed: Apr. 20, 2007

(30) Foreign Application Priority Data
Mar. 8, 2007 (KR) 10-2007-22717

(51) Int. Cl. B32B 9/04

(52) U.S. Cl. 428/446; 428/411.1; 428/688

(57) ABSTRACT

A finishing material panel for a construction material is disclosed, which comprises an expanded vermiculite of 35˜45 weight % having heat keeping, adiabatic and inflammable functions, a yellow earth of 5˜15 weight % or white earth of 5˜15 weight %, a fibroid component of 5˜15 weight %, water of 30˜40 weight %, and at least one sub-material of 5˜10 weight % selected from the group consisting of silica, charcoal, illite, jade, elva, and aroma. Pores are formed as fibroid is dried, and inflammable effects are excellent owing to expanded vermiculite and silica.

### BACKGROUND OF THE INVENTION

1. Field of the Invention

The present invention relates to a finishing material panel for a construction material, and in particular to a finishing material panel for a construction material which is good for a human body since natural components such as expanded vermiculite, yellow earth, fibroid material, silica, wooden, etc. are used. In addition, the finishing material panel has an excellent inflammable function and soundproof function owing to vermiculite pores and water-soluble silica.

2. Description of the Background Art

A conventional finishing interior material is made by applying paint on or by attaching wallpaper to a finishing material such as concrete, ALC (light expandable cement), polyurethane, etc. The fishing material contains radioactivity substance and environment pollution substance. The expandable resin such as polyurethane is very weak to heat and generates toxic gas in the course of fire.

In case of yellow earth finishing material, since the major source material is yellow earth, cracks may be formed while it is being dried. When the yellow earth is molded in a flat shape, it is very weak to external force. When the yellow earth is molded in a large size tile shape, it has a very weak bending stress, so that it may be easily bent in the course of dry. When the yellow earth is used for a ceiling board, the finished yellow earth may be sagged.

### SUMMARY OF THE INVENTION

Accordingly, it is an object of the present invention to provide a finishing material panel for a construction material which enhances the strength of a finishing material and an inflammable function owing to the use of expanded vermiculite and silica. A soundproof effect is excellent since pores are formed. The finishing material panel is made of yellow earth or white earth, which is natural component and has harmful substance collection and decomposition functions and generates wide range wavelengths and anion activating a human body.

It is another object of the present invention to provide a finishing material panel for a construction material which is good for a human body since natural components such as silica, charcoal, illite, jade, elva, aroma, etc. are added as sub-materials. In addition, the finishing material panel is made of porous materials, so that adiabatic function, aroma function, far-infrared radiation function, sound absorption and soundproof functions are enhanced.

To achieve the above objects, there is provided a finishing material panel for a construction material which comprises an expanded vermiculite of 35˜45 weight %; a yellow earth of 5˜15 weight % or white earth of 5˜15 weight %; a fibroid component of 5˜15 weight %; water of 30˜40 weight %; and at least one sub-material of 5˜10 weight % selected from the group consisting of silica, charcoal, illite, jade, elva, and aroma.

According to a preferred feature of the present invention, the fibroid is formed of at least one component selected from the group consisting of a white tree bark of the paper mulberry, which is a material of Korean paper, waste paper, waste bill and waste wood.

According to a more preferred feature of the present invention, the silica is water-soluble.

### DETAILED DESCRIPTION OF THE PREFERRED EMBODIMENTS

The finishing material panel for a construction material according to the present invention comprises expanded vermiculite of 35˜45 weight %, yellow earth of 5˜15 weight % or white earth of 5˜15 weight %, fibroid component of 5˜15 weight %, water of 30˜40 weight %, and at least one sub-material of 5˜10 weight % selected from the group consisting of silica, charcoal, illite, jade, elva, and aroma.

In particular, the expanded vermiculite has excellent sound absorption effects owing its pores.

The yellow earth has excellent far-infrared radiation effects. When the crystal component occupying 50% of the total components is stimulated by various heat sources such as warming heat, etc., it generates far-infrared radiation which is used for a medical massage owing to its high absorption to a human body. The far-infrared radiation activates the cells, and allows various wastes to discharge from a human body.

In addition, the yellow earth emits anion which is small molecular having electricity. The anion allows a person in forest to feel freshness. The anion decomposes even small amount of harmful substances.

The yellow earth has a moisture control function. The clay, which is a kind of illite and is contained as one of the major components, has a function of absorbing moisture in the air when it is humid and on the contrary of discharging moisture when it is dry, so that the indoor moisture is properly controlled.

The yellow earth has excellent adiabatic and soundproof functions, of which crystal, which is a major component, is known to have good adiabatic function. The small spaces formed between the particles of the yellow earth are able to prevent the heat and sound from being transferred. In summer or winter, the small spaces enhance the cooling and warming efficiency of the indoor space and block off various noises, so that a comfortable indoor space is obtained while not being disturbed from the outside.

The fibroid is formed of at least one component selected from the group consisting of a white tree bark of the paper mulberry, which is a material of Korean paper, waste paper, waste bill and waste wood. Here, the pores formed as the fibroid is dehydrated have sound absorption functions.

The present invention is directed to a finishing material panel for a construction material which is molded by mixing necessary substances with natural components using a compression press machine having a frame.

1) Mixing Process

The above process is for manufacturing a mixture.

Expanded vermiculite of 35˜45 weight %, yellow earth of 5˜15 weight % or white earth of 5˜15 weight %, fibroid component of 5˜15 weight %, water of 30˜40 weight %, and at least one sub-material of 5˜10 weight % selected from the group consisting of silica, charcoal, illite, jade, elva, and aroma are mixed in a mixer for 30 minutes.

The mixture is dried. When the dry process is finished, the mixture can be used directly. However, when the dry process is not performed, a substantially dried mixture is made through a dry and plastic process.

2) Molding Process

The substance made through the above process is inserted into a press machine having a rectangular molding frame of 30˜90 mm and is compressed and molded.

3) Dry Process

The panel formed through the above molding process is dried for 2 days at 80° C. The finished panel can be used as a construction interior material.

As described above, the finishing material panel for a construction material according to the present invention has excellent inflammable function owing expanded vermiculite and silica and has excellent soundproof effects owing to the pores. In addition, the present invention has a function of collecting and decomposing harmful substances by using natural yellow and white earth and of discharging various range wavelength and anion which are known to activate a human body.

In addition, the finishing material panel for a construction material according to the present invention is not harmful to a human body since natural components such as silica, charcoal, illite, jade, elva, and aroma are provided. The finishing panel for the same is porous, so that adiabatic, aroma, far-infrared radiation, sound absorption and soundproof effects are excellent.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A finishing material panel for a construction material, comprising:
an expanded vermiculite of 35˜45 weight %;
a yellow earth of 5˜15 weight % or white earth of 5˜15 weight %;
a fibroid component of 5˜15 weight %;
water of 30˜40 weight %; and
at least one sub-material of 5˜10 weight % selected from the group consisting of silica, charcoal, illite, jade, elva, and aroma.

2. The panel of claim 1, wherein said fibroid is formed of at least one component selected from the group consisting of a white tree bark of the paper mulberry, which is a material of Korean paper, waste paper, waste bill and waste wood.

3. The panel of claim 1, wherein said silica is water-soluble.
